(19) United States
(12) Patent Application Publication
(10) Pub. No.: US 2006/0087706 A1
(43) Pub. Date: Apr. 27, 2006

(54) Method of compensating color tone for color printer and color printer having color tone compensator

(75) Inventors: Woo-jung Shim, Suwon-si (KR); Jin-cheol Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/250,414

(22) Filed: Oct. 17, 2005

(30) Foreign Application Priority Data
Oct. 22, 2004 (JP) 10-2004-0084856

(51) Int. Cl. H04N 1/46

(52) U.S. Cl. 358/504

(57) ABSTRACT

A tone compensation method for a color printer and a color printer having a tone compensator are provided, wherein the method includes the steps of (a) acquiring a reference tone reproduction curve of print colors based on a printing environment, (b) forming sample patterns for one or more colors on a predetermined object medium, (c) forming a sectional tone reproduction curve by using the sample patterns, and (d), adjusting one or more print variables to compensate the sectional tone reproduction curve in order to reduce sectional errors between the reference tone reproduction curve and the sectional tone reproduction curve. Accordingly, it is possible to provide a tone compensation method capable of compensating for a sectional tone reproduction curve to approximate a reference tone reproduction curve without complicated mathematical calculations, and which is substantially unaffected by external disturbances and noise.

### CROSS-REFERENCE TO RELATED PATENT APPLICATIONS

This application claims the benefit under 35 U.S.C. 119(a) of Korean Patent Application No. 10-2004-0084856, filed in the Korean Intellectual Property Office on Oct. 22, 2004, the entire disclosure of which is incorporated herein by reference.

### BACKGROUND OF THE INVENTION

1. Field of the Invention

The present invention relates to a color printer. More particularly, the present invention relates to a color printer having a tone compensation unit and a tone compensation method.

2. Description of the Related Art

As electronics have developed, a variety of image pick-up apparatuses have been designed and become widely used. The image pick-up apparatuses include design implementations used in image-pick-up-function-built-in mobile phones, digital cameras, digital camcorders, and the like. The performance of the image pick-up apparatus has been greatly improved, and their prices have been lowered. In addition, these image pick-up apparatuses have been constructed to be more compact and lighter. Therefore, a user can more easily carry an image pick-up apparatus and have the ability to capture images at any place and at any time. In addition, a variety of image printing apparatuses, such as printers for printing the image, have also been designed and have become widely used.

Color printers, which are one of these image printing apparatuses, print the images using various printing methods. For example, the printing methods can include a bubble jet method, inkjet method, electro-photographic method, thermal sensitive method, and other such methods. In an electro-photographic color printer using the electro-photographic method, a toner is developed on an electrostatic latent image formed on an organic photosensitive medium, and the developed electrostatic latent image is transferred onto a printing paper. A high-quality printing material can be obtained with the electro-photographic color printer.

However, the color reproduction capability of the color printers depends on various environmental factors. In the case of the electro-photographic color printer, the environmental factors can include operating temperature, operating humidity, time-varying characteristics of a printer used over a long period of time, and a change in the characteristics of the principal parts, such as the organic photosensitive medium and the toner, and a change in the characteristics of a power voltage and a developing voltage. Therefore, in order to obtain a constant quality of printed material, a tone compensation method for the color printer is used to cope with the environmental factors.

FIG. 1 is a block diagram of a conventional tone compensation apparatus of a color printer. The conventional tone compensation apparatus comprises a Jacobian matrix unit 110, an integrator 130, a compensator 170, and first and second adders 190 and 150. The first adder 190 calculates a deviation from a result of a comparison of a developed mass per area (DMA) for a sample pattern, and a DMA detected by a sensor. The first adder 190 receives an input vector of at least one primary color in order to represent a color.

The Jacobian matrix unit 110 includes an inverse matrix of the Jacobian matrix in an operating condition of the color printer. The integrator 130 integrates the output of the Jacobian matrix unit 110 and transmits the output of the integrator 130 to the second adder 150. The second adder 150 adds nominal set point values to the received output of the integrator 130, and outputs a compensation value. The output compensation value is transmitted to the compensator 170.

The tone compensation apparatus of FIG. 1 calculates the Jacobian matrix and performs a compensation operation by using the inverse Jacobian matrix. More specifically, the compensation operation is performed by changing the developing voltage, grid voltage, and exposure energy (that is, a laser diode power).

The specific compensation operation will now be described in greater detail. Firstly, a tone reproduction curve (TRC) is acquired by using the DMA detected from at least one of the sample patterns. In addition, a sectional error between the TRC and a reference tone reproduction curve (RTRC) is calculated. The calculated sectional error is applied to a gain compensator (not shown) of the Jacobian matrix unit 110, and the output of the gain compensator passes through the integrator 130 to be added to the nominal set point values, thereby generating a control value (that is, the compensation value). As shown in FIG. 1, the conventional tone compensation apparatus includes a Jacobian matrix unique to each of the nominal set point values.

The DMA is proportional to the developing voltage and reversely proportional to the grid voltage. If the measured DMA is smaller than a reference DMA, in order to control the developed mass, the developing voltage is decreased, or the grid voltage is increased. If the measured DMA is larger than the reference developed mass, the opposite adjustment is performed to control the developed mass. Similarly, the DMA is proportional to the exposure energy.

The aforementioned Jacobian matrix denotes a charge rate of the TRC as the only one of the multiple print variables that is allowed to vary at an arbitrary nominal set point value. The Jacobian matrix is used to control a non-linear system. More specifically, the Jacobian matrix is used to approximate a linear system from a non-linear system by performing a linearization of an arbitrary variable at a specific section. Due to the linearization, the non-linear system can be easily controlled. Therefore, for a given Jacobian matrix, the conventional tone compensation apparatus utilizes the inverse matrix of the given Jacobian matrix for the compensation operation.

FIG. 2 shows sample patterns 250 used for the conventional tone compensation method for a color printer. The sample patterns 250 are formed on a photosensitive medium 210. As the photosensitive medium 210 proceeds in a predetermined progressing direction, a tone sensor 230 sequentially detects tones of the sample patterns 250. The tone sensor 230 illuminates an optical signal such as infrared (IR) light and visible light on the sample patterns 250, and detects the reflected light. Based on the reflected light, the tone sensor 230 senses the DMA of the sample patterns 250, and converts the reflected optical signal into an electrical signal. The sample patterns 250 developed on the photosensitive medium 210 have different tone densities and are separated from each other in a predetermined interval.

FIG. 3 is a flowchart of a conventional tone compensation method. Firstly, the DMA of the sample patterns 250 are measured at step (S310). A deviation between the measured DMA and reference DMA is calculated at step (S330). The calculated deviation is compared with a predetermined allowable value at step (S350). If the deviation is larger than the allowable value, a compensation degree for a printing value is calculated at step (S370). Finally, the compensation operation is performed based on the compensation degree for the printing value at step (S390).

However, the conventional tone compensation method has a number of shortcomings. Firstly, the conventional tone compensation method has typically been used with a Jacobian matrix having a low accuracy. Performance and reliability of a conventional DMA control method and compensation method depend on the accuracy of the Jacobian matrix. The Jacobian matrix is time-varying according to the aforementioned environmental factors, such as temperature and humidity, as well as changes in the power voltage and the non-linearity of the characteristics of the parts of the color printer. In order to improve print quality, the Jacobian matrix must be modified according to the changes of the environmental factors. In addition, the developing characteristics vary according to changes in a charge quantity (that is, a specific charge quantity) of developers due to the changes of the environmental factors. Therefore, the accuracy of the Jacobian matrix is further lowered.

Secondly, since the developers may not be uniformly distributed, the measured value of the TRC may also have an error. If the TRC has an error, the matrix calculation for adjusting print variables may become indefinite or even impossible. As a result, the print variables may not be determined at optimal values. Therefore, the accuracy of the conventional tone compensation method for a color printer using the Jacobian matrix may be lowered due to the influence of internal and external disturbances and noise.

Thirdly, the conventional tone compensation method involves a very complicated calculation for obtaining the inverse Jacobian matrix, so that the conventional tone compensation method cannot be easily implemented.

Accordingly, a need exists for a system and method for providing a simple tone compensation method that is unaffected by disturbances and noise.

### SUMMARY OF THE INVENTION

The present invention substantially solves the above and other problems, and provides a tone compensation method that is capable of calculating an accurate tone reproduction curve from a measured tone reproduction curve having disturbances. Namely, the present invention provides a tone compensation method with a mathematical calculation process that is substantially unaffected by disturbances.

The present invention also provides a tone compensation method having an improved accuracy.

The present invention also provides a tone compensation method that is capable of concentrating a compensation process on more important sections of a tone reproduction curve by allocating sectional weighted values to the sections in the tone reproduction curve.

According to an aspect of the present invention, a tone compensation method for a color printer is provided comprising the steps of (a) acquiring a reference tone reproduction curve of print colors based on a printing environment, (b) forming sample patterns for one or more colors on a predetermined object medium, (c) forming a sectional tone reproduction curve by using the sample patterns, and (d), adjusting one or more print variables to compensate the sectional tone reproduction curve in order to reduce sectional errors between the reference tone reproduction curve and the sectional tone reproduction curve.

The operation of step (a) may comprise the steps of (a1) reading a tone compensation curve based on the print environment, and (a2), forming the reference tone reproduction curve having a complementary relation to the tone compensation curve.

In addition, the operation of step (b) may comprise the steps of (b1) forming the sample patterns of one or more tones for one of one or more primary colors to implement colors, and (b2), repeating the operation of steps (b1) for different primary colors.

In addition, the operation of step (c) may comprise the steps of (c1) reading the sample patterns, and (c2), forming the sectional tone reproduction curve based on a relation between the tone formed in the sample patterns and the tone read from the sample patterns.

In addition, the operation of step (d) may comprise the steps of (d1) determining whether or not compensation for the sectional tone reproduction curve is needed by using a sum of deviations determined based on quantities of the sectional errors, (d2) compensating the sectional tone reproduction curve by using weighted deviations determined by allocating weighted values to the sectional errors if the compensation is needed, and (d3), storing the adjusted print variables.

According to another aspect of the present invention, a color printer is provided comprising a memory unit for storing a reference tone reproduction curve of print colors based on a printing environment, a sample pattern formation unit for forming sample patterns for one or more colors on a predetermined object medium, a sectional tone reproduction curve formation unit for forming a sectional tone reproduction curve by using the sample patterns, and a tone compensation unit for adjusting one or more print variables to compensate the sectional tone reproduction curve in order to reduce sectional errors between the reference tone reproduction curve and the sectional tone reproduction curve.

The tone compensation unit may comprise a compensation determination unit for determining whether or not compensation for the sectional tone reproduction curve is needed by using a sum of deviations determined based on quantities of the sectional errors, and a sectional compensation unit for compensating the sectional tone reproduction curve by using weighted deviations determined by allocating weighted values to the sectional errors if the compensation is needed, wherein the memory unit stores the adjusted print variables.

In addition, the sectional compensation unit may be configured to divide the sectional tone reproduction curve into one or more sections based on tone, determine weighted values according to degrees of importance of the divided sections, calculate the weighted deviations of the divided sections by allocating the weighted values to the sectional errors, and adjust the print variables to compensate the sectional tone reproduction curve by using the weighted deviations.

In addition, the tone compensation unit may be configured to determine whether or not the weighted deviation is equal to or greater than a second threshold value, and repeat compensation if the weighed deviation is equal to or greater than the second threshold value.

According to embodiments of the present invention, it is possible to implement a tone compensation method that is substantially unaffected by disturbances and having a high accuracy.

In addition, according to embodiments of the present invention, it is possible to implement a tone compensation method that is capable of concentrating a compensation process on more important sections of the tone reproduction curve.

### BRIEF DESCRIPTION OF THE DRAWINGS

The above and other features and advantages of the present invention will become more apparent by describing in detail exemplary embodiments thereof with reference to the attached drawings, in which:

FIG. 1 is a block diagram of a conventional color printer and tone compensation unit;

FIG. 2 is a view showing sample patterns used for a tone compensation method for a conventional color printer;

FIG. 3 is a flowchart showing a conventional tone compensation method;

FIG. 4 is a block diagram of a color printer using a tone compensation method according to an embodiment of the present invention;

FIG. 5 is a view showing sample patterns used for a tone compensation method according to an embodiment of the present invention;

FIG. 6A is a graph showing an ideal tone reproduction curve;

FIGS. 6B and 6C are graphs showing a tone compensation curve and a reference tone reproduction curve having a complementary relation thereto, respectively;

FIGS. 6D and 6E are graphs showing another example of a tone reproduction curve read out from multiple sample patterns and sections divided from the tone reproduction curve based on tones;

FIG. 7 is a flowchart showing a tone compensation method according to an embodiment of the present invention; and

FIG. 8 is a flowchart showing a print variable adjusting operation in the tone compensation method shown in FIG. 7 in greater detail.

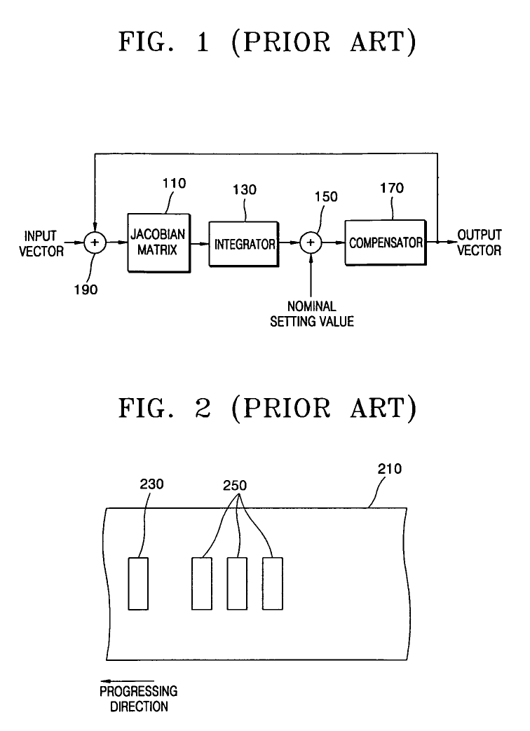

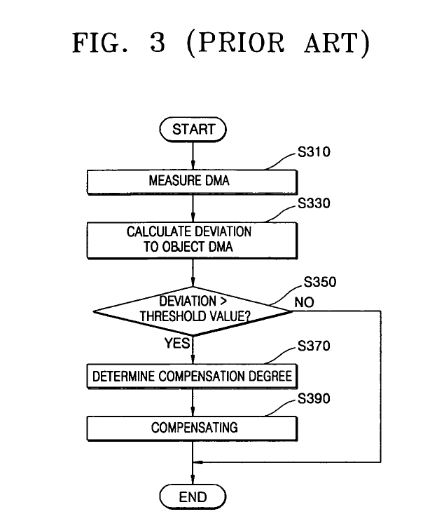

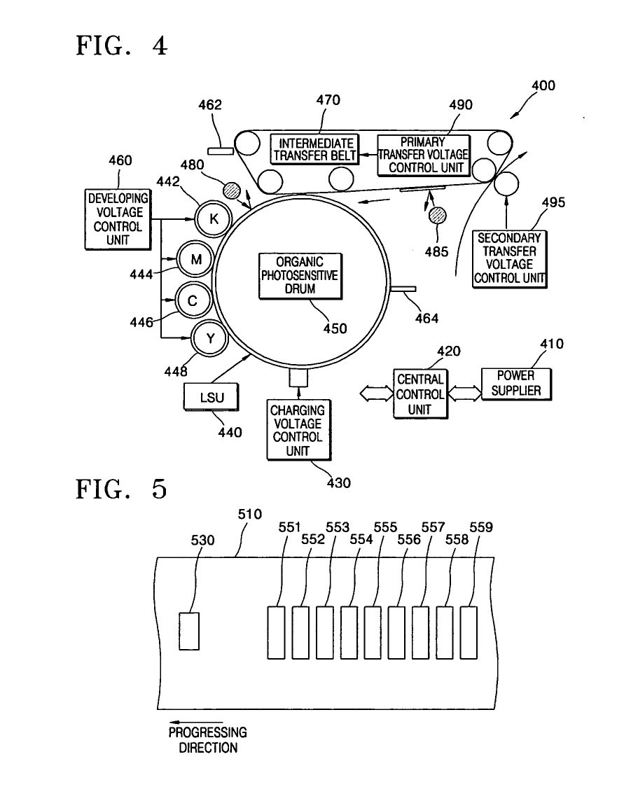

Throughout the drawings, like reference numerals will be understood to refer to like parts, components and structures.

### DETAILED DESCRIPTION OF THE EXEMPLARY EMBODIMENTS

The attached drawings are provided for illustrating exemplary embodiments of the present invention, and are referred to in order to describe embodiments of the present invention, merits thereof, and objectives accomplished by the implementation of the present invention. Hereinafter, the present invention will be described in detail by explaining exemplary embodiments of the present invention with reference to the attached drawings.

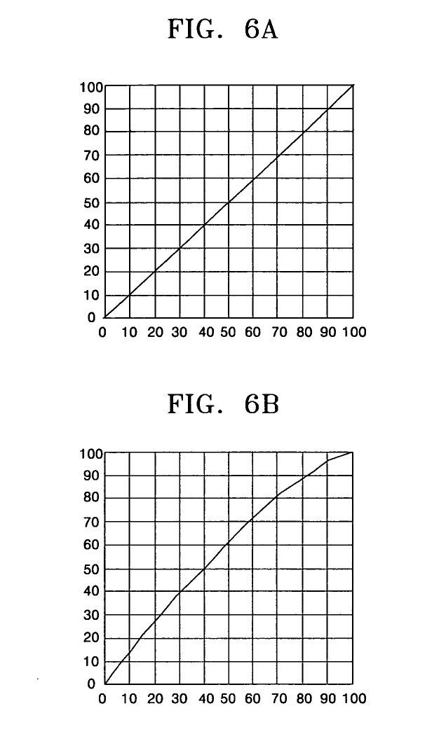

FIG. 4 is a block diagram of a color printer using a tone compensation method according to an embodiment of the present invention. In this exemplary embodiment of the present invention, the color printer is comprised of an electronic picture color printer 400, but is not limited thereto. The electronic picture color printer 400 is comprised of a power supplier 410, a central control unit 420, a charging voltage control unit 430, a laser scanning unit (LSU) 440, an organic photosensitive drum 450, a developing voltage control unit 460, an intermediate transfer belt 470, a primary transfer voltage control unit 490, and a secondary transfer voltage control unit 495. In addition, the color printer 400 is also comprised of developing cartridges 442, 444, 446, and 448 for containing black (K), magenta (M), cyan (C), and yellow (Y) developer, a cleaning blade 464 for recovering used developer remaining on the organic photosensitive drum 450, and first and second CTD (color tone density) sensors 480 and 485.

The charging voltage control unit 430 charges the organic photosensitive drum 450 with a predetermined voltage. The laser scanning unit 440 illuminates a laser beam, modulated according to a printing image, on the charged organic photosensitive drum 450 in order to form an electrostatic latent image on the organic photosensitive drum 450. The developing voltage control unit 460 applies a developing voltage having DC and AC components to the organic photosensitive drum 450 in order to attach the developer on the electrostatic latent image formed on the organic photosensitive drum 450. The developer attached by the developing voltage control unit 460 is primarily transferred to the intermediate transfer belt 470. After all the primary colors of the image are transferred to the intermediate transfer belt 470, the secondary transfer voltage control unit 495 secondarily transfers the transferred image to a medium, such as a paper. In addition, the color printer 400 may further comprise a fixing unit (not shown) for fixing the transferred image on the paper by using heat or pressure.

The power supplier 410 supplies a power voltage to the components of the color printer 400. The central control unit 420 controls the operations of the color printer 400.

When the color printer is turned on, the central control unit 420 reads a reference tone reproduction curve (RTRC) corresponding to an operation environment condition from a memory unit (not shown). The laser scanning unit 440 forms sample patterns on the organic photosensitive drum 450. The sample patterns formed on the organic photosensitive drum 450 are then read by the first color tone density sensor 480, and the central control unit 420 forms a sectional tone reproduction curve (STRC) by using the tone values in the read sample patterns. In addition, the sample pattern may be formed on the intermediate transfer belt 470 and read by the second color tone density sensor 485.

Next, the central control unit 420 controls various print variables by using sectional errors between the RTRC and the STRC, so that the STRC can be compensated to approximate the RTRC. This operation is described in greater detail below.

The memory unit stores the RTRC of printing colors based on the print environment. The memory unit may be provided in the central control unit 420, or may be provided separately. The LSU 440 forms sample patterns for one or more tones on the organic photosensitive drum 450 or the intermediate transfer belt 470. Preferably, the formed sample patterns maintain the same tone differences. The central control unit 420 reads the formed sample patterns to form the STRC. Next, the central control unit 420 compensates the STRC to reduce the sectional errors between the STRC and the RTRC. The print variables include, but are not limited to, a magnitude of a DC component of a developing voltage, a magnitude of an AC component of the developing voltage, a duty cycle of the AC component of the developing voltage, a charging voltage for the organic photosensitive medium, and a control voltage of the laser diode. The central control unit 420 can simultaneously control one or more print variables to acquire an optimal print variable vector. Alternatively, in addition to the central control unit 420, a tone compensation unit (not shown) may be provided to compensate the STRC in yet another embodiment of the present invention.

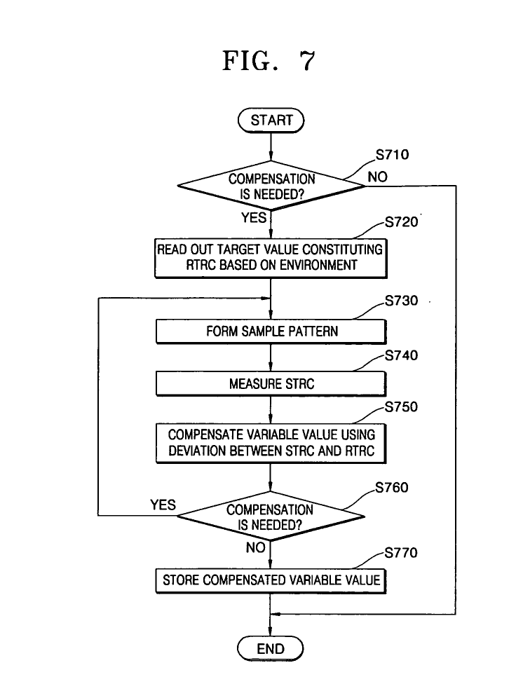

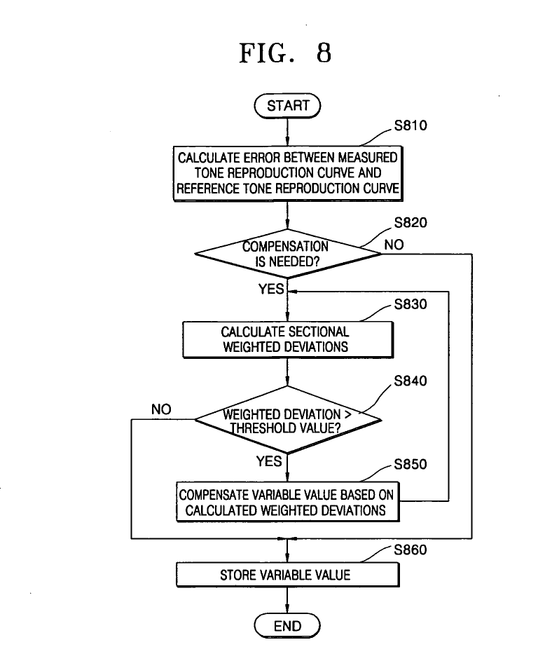

The central control unit 420 determines whether or not compensation for the STRC is needed by using a sum of deviations determined based on quantities of the sectional errors. The sum of deviations may be a sum of absolute values of the sectional errors, or a sum of squares of the sectional errors. If compensation of the STRC is determined to be needed, the central control unit 420 compensates for the STRC by using weighted deviations determined by allocating the respective weighted values to the sectional errors. By allocating the sectional weighted values to the STRC, it is possible to concentrate the compensation process on more important sections of the curve. In general, it is well known to those skilled in the art that human eyes are more sensitive to the errors of lower tones. Therefore, in embodiments of the present invention, a higher weighted value may be allocated to a lower tone section. The central control unit 420 repeatedly compensates for the STRC until the weighted deviations allocated by the weighted values are lower than a predetermined value. The adjusted print variables may then be stored in a memory (not shown). The STRC compensation operation of the central control unit 420 will be described in greater detail below with reference to FIGS. 7 and 8.

An exemplary print variable adjustment operation is performed as follows. As the charging voltage control unit 430 increases the charging voltage, the DMA decreases. In addition, as the developing voltage control unit 460 increases the developing voltage, the DMA also increases. The developing voltage has both DC and AC components. As the AC components of the developing voltage increase, the DMA increases. In addition, as the duty cycle of the AC components of the developing voltage increase, the DMA increases. In addition, as the power voltage supplied by the power supplier 410 increases, the DMA increases. By taking these relationships into consideration, the print variables, that is, the operating conditions of the parts of the printer 400 can be adjusted.

As described above, it should be noted that the printing environment of the color printer 400 varies according to changes in operating temperature, operating humidity, characteristics of power voltage supplied to the color printer, and time-varying characteristics of the parts of the color printer. If the print environment varies, the RTRC suitable for the print environment must be read out.

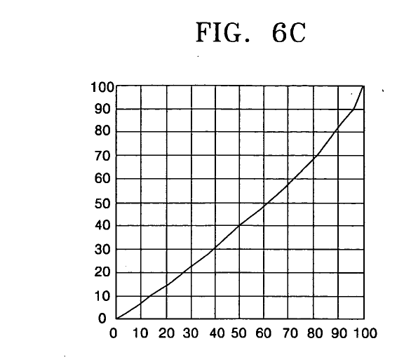

FIG. 5 is a view showing sample patterns used for a tone compensation method according to an embodiment of the present invention. As described above, the object medium 510 may be an organic photosensitive drum or an intermediate transfer belt. The exemplary object medium 510 includes nine sample patterns 551 to 559, but is not limited thereto. Although the sample patterns maintain the same tone difference, more sample patterns are used for the more important sections of the curve. As the sample patterns 551 to 559 proceed in a predetermined progressing direction, the color tone density (CTD) sensor 530 sequentially detects the sample patterns 551 to 559, and detects the DMAs for the sample patterns 551 to 559. Unlike the conventional sample patterns, there are nine sample patterns 551 to 559 provided, so that it is possible to accurately implement the STRC.

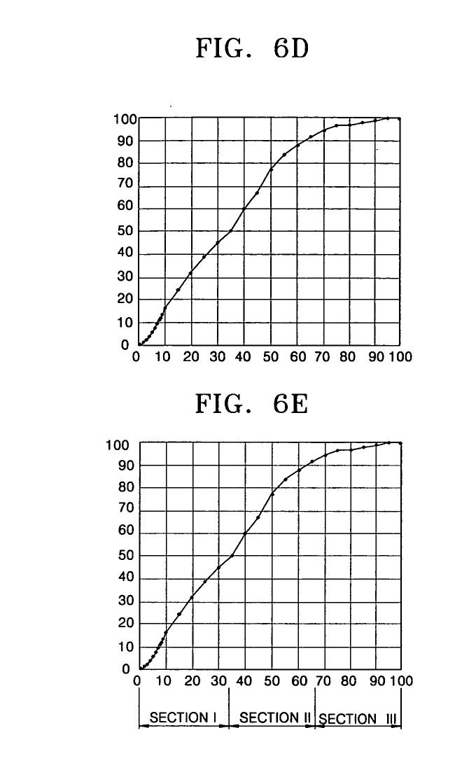

FIG. 6A is a graph showing an ideal TRC. In the ideal TRC, the horizontal axis indicates input tones, and the vertical axis indicates output tones. The ideal TRC corresponds to a case where desired accurate tones are obtained. Preferably, the ideal TRC is linear. However, since the TRC of a printer engine is non-linear, the linearity of the TRC is compensated by using a tone compensation curve (TCC).

FIGS. 6B and 6C are graphs showing a TCC and an RTRC having a complementary relation thereto, respectively. FIG. 6B shows the TCC, and FIG. 6C shows the RTRC in a specific print environment. If the RTRC is formed in the specific printer environment, the TCC that is capable of compensating for the RTRC is stored as a look-up table. As noted above, the operation characteristics of the printer vary according to changes due to factors such as depreciation of the printer and printer parts used over a long period of time, such as the organic photosensitive drum and developers. Therefore, the TRC also varies.

FIGS. 6D and 6E are graphs showing another example of a TRC read out from multiple sample patterns and sections divided from the TRC based on tones.

Here, it is assumed that the TRC of FIG. 6D is compensated by using the RTRC of FIG. 6C, however, this assumption is provided merely for the convenience of the following description. Therefore, the present invention is not limited thereto.

Firstly, the TRC of FIG. 6D is divided into sections based on the tones. As a result, the STRC of FIG. 6E is obtained. The STRC is divided into three sections, including sections I, II, and III. The section I has a tone ranging from 0 to 33%, the section II has a tone ranging from 33% to 66%, and the section III has a tone ranging from 66% to 100%. The division of the sections is merely provided as an example, and any number of divisions and division ranges can be used.

The STRC is divided in order to allocate the higher weighted value to more important sections of the curve. The allocation of the sectional weighted values to the sections will be described in greater detail below with reference to FIG. 8.

FIG. 7 is a flowchart showing a tone compensation method according to an embodiment of the present invention. When the color printer is turned on, it is determined whether or not the compensation for the TRC is needed at step (S710). Compensation for the TRC is determined to be needed in cases where the color printer proceeds into a cold start, where consumables such as a toner cartridge, an organic photosensitive drum, an intermediate transfer belt and the like are replaced, and where a predetermined number of printing paper sheets are printed. In addition, a user may arbitrarily direct the compensation operation.

If the compensation for the TRC is determined to be needed, target DMA values constituting the RTRC are read out based on the print environments at step (S720). The target DMA values correspond to points in the RTRC graph.

Next, sample patterns are formed on the object medium such as the organic photosensitive drum and the intermediate transfer belt at step (S730). Here, each of the sample patterns has at least one tone for each primary color. Next, the tones of the formed sample patterns are read out by using the CTD, and the STRC is measured by using the read-out tones at step (S740). After the STRC is measured, the STRC is compensated to approximate the RTRC by using the sectional errors between the STRC and the RTRC at step (S750). The compensation operation for the STRC can be performed by adjusting a variety of the print variables of the printer, as described above.

When the compensation operation is completed, it is then determined whether or not the compensation for other primary colors is needed at step (S760). After the compensation for all the primary colors is completed, the resulting print variables are stored at step (S770). As shown in FIG. 7, multiple control variables are used to generate an STRC that most approximates the RTRC. Therefore, it is easy to optimize the STRC by using a set of multiple control variables. In addition, since the multiple control variables are used, the compensation operation is substantially unaffected by external noise, and the influence of changes in each control variable on the entire TRC can be minimized.

FIG. 8 is a flowchart showing a print variable adjusting operation in the tone compensation method shown in FIG. 7 in greater detail. Firstly, the detected TRC is divided into predetermined sections to obtain the STRC, and the sectional errors between the obtained STRC and the RTRC are calculated at step (S810). Next, it is determined whether or not the compensation for the STRC is needed by using the sum of deviations determined based on the sectional errors at step (S820). Since each sectional error can have a positive or negative value, each sectional error itself is preferably not used for the calculation. Therefore, the sum of deviations, a positive value, is used. The sum of deviations may be a sum of absolute values, or a sum of the squares of sectional errors. It can be understood that any mathematical calculation for removing a sign of the sectional errors and summing the resulting values can be used.

If the compensation is determined to be needed, the weighted deviations are calculated by allocating weighted values to the sectional errors of the STRC at step (S830). As described above, the object of the allocation of the weighted values to the sectional errors is to concentrate the compensation operation on more important sections of the curve. For example, weighted values of 3, 2, and 1, may be allocated to the sections I, II, and III, respectively.

After the weighted deviations allocated by the weighted values are obtained, it is then determined whether or not the weighted deviations are larger than a predetermined value at step (S840). If the weighted value is not larger than the predetermined value, it is unnecessary to compensate the STRC at the associated section. If the weighted value is larger than the predetermined value, the print variables are adjusted to compensate the STRC by using the weighted deviations at step (S850).

After the print variables are adjusted, the compensation operation returns to the operation at step (S830) to calculate the sectional weighted deviations. In this manner, the compensation operation repeats until the weighted deviations are not larger than the predetermined value.

Finally, if the weighted deviations are determined to be less than the predetermined value, the compensation operation is completed and the resulting print variables are stored at step (S860).

It can be understood that the print variable adjustment operation shown in FIG. 8 can be repeated for each of the primary colors.

According to embodiments of the present invention, the following advantages can be obtained.

Firstly, unlike a conventional method, it is unnecessary to perform any complicated mathematical calculation for compensating for a sectional tone reproduction curve (STRC). Therefore, it is possible to avoid calculation errors caused by external disturbances or noise.

Secondly, since multiple print variables are used to compensate the STRC, it is possible to minimize a probability of failure of the compensation operation caused by a specific print variable.

Thirdly, since different weighted values are allocated to sections of the divided TRC, it is possible to concentrate the compensation operation on the human-eye-sensitive section.

Fourthly, since a set of print variables is acquired by repeating the compensation operation, it is easy to compensate the STRC to approximate a reference tone reproduction curve (RTRC).

According to the present invention, since a complicated mathematical calculation of a conventional method can be avoided, it is possible to provide a tone compensation method with a mathematical calculation process that is substantially unaffected by disturbances.

In addition, according to the present invention, it is possible to provide a tone compensation method with an improved accuracy.

In addition, according to the present invention, since sectional weighted values are allocated to sections of a tone reproduction curve (TRC), it is possible to provide a tone compensation method capable of concentrating a compensation operation on the more important sections of the curve.

While the present invention has been particularly shown and described with reference to exemplary embodiments thereof, it will be understood by those skilled in the art that various changes in form and details may be made therein without departing from the spirit and scope of the present invention. For example, although a color printer is described as the electro-photographic printer in the above description, the present invention is not limited thereto, but can be used to compensate for tones of any kind of color printer. In addition, although the primary colors in the above description are exemplified as black, magenta, cyan, and yellow, it is obvious that other kinds of colors such as red, green, and blue, can be used for the primary colors. Therefore, the scope of the present invention is defined not by the detailed description of the invention but by the appended claims, and all differences within the scope will be construed as being included in the present invention.

What is claimed is:

1. A tone compensation method for a color printer, comprising the steps of:
(a) acquiring a reference tone reproduction curve of print colors based on a printing environment;
(b) forming sample patterns for one or more colors on a predetermined object medium;
(c) forming a sectional tone reproduction curve by using the sample patterns; and
(d) adjusting one or more print variables to compensate the sectional tone reproduction curve in order to reduce sectional errors between the reference tone reproduction curve and the sectional tone reproduction curve.

2. The tone compensation method according to claim 1, wherein the operation of step (a) comprises the steps of:
(a1) reading a tone compensation curve based on the print environment; and
(a2) forming the reference tone reproduction curve having a complementary relation to the tone compensation curve.

3. The tone compensation method according to claim 1, wherein the operation of step (b) comprises the steps of:
(b1) forming the sample patterns of one or more tones for one of one or more primary colors; and
(b2) repeating the operation of step (b1) for different primary colors.

4. The tone compensation method according to claim 1, wherein the operation of step (c) comprises the steps of:
(c1) reading the sample patterns: and
(c2) forming the sectional tone reproduction curve based on a relation between the tone formed in the sample patterns and the tone read from the sample patterns.

5. The tone compensation method according to claim 1, wherein the operation of step (d) comprises the steps of:
(e) determining whether or not compensation for the sectional tone reproduction curve is needed by using a sum of deviations determined based on quantities of the sectional errors;
(f) compensating the sectional tone reproduction curve by using weighted deviations determined by allocating weighted values to the sectional errors if the compensation is needed; and
(g) storing the adjusted print variables.

6. The tone compensation method according to claim 5, wherein the operation of step (e) comprises the steps of:
(e1) calculating the sum of deviations by summing absolute values of the sectional errors;
(e2) determining whether or not the sectional errors are equal to or greater than a first threshold value; and
(e3) determining that the compensation for the sectional tone reproduction curve is needed if the sectional errors are equal to or greater than the first threshold value.

7. The tone compensation method according to claim 5, wherein the operation of step (e) comprises the steps of:
(e1) calculating the sum of deviations by squaring the sectional errors;
(e2) determining whether or not the sectional errors are equal to or greater than a first threshold value; and
(e3) determining that the compensation for the sectional tone reproduction curve is needed if the sectional errors are equal to or greater than the first threshold value.

8. The tone compensation method according to claim 5, wherein the operation of step (f) comprises the steps of:
(f1) dividing the sectional tone reproduction curve into one or more sections based on tone and determining a degree of importance of at least one section;
(f2) determining weighted values according to the degrees of importance of the divided sections;
(f3) calculating the weighted deviations of the divided sections by allocating the weighted values to the sectional errors; and
(f4) adjusting the print variables to compensate the sectional tone reproduction curve by using the weighted deviations.

9. The tone compensation method according to claim 8, wherein the operation of step (f1) comprises the step of dividing the sectional tone reproduction curve into at least three sections.

10. The tone compensation method according to claim 9, wherein the operation of step (f2) comprises the step of allocating a higher weighted value to a section having a lower tone in the sectional tone reproduction curve.

11. The tone compensation method according to claim 5, wherein the operation of step (f) comprises the steps of:
(f5) determining whether or not the weighted deviation is equal to or greater than a second threshold value; and
(f6) repeating compensation if the weighed deviation is equal to or greater than the second threshold value.

12. The tone compensation method according to claim 1, wherein the color printer is an electronic-picture color printer comprising:
a charger for charging an organic photosensitive medium;
a laser diode for forming an electrostatic latent image on the organic photosensitive medium;
a developing unit for developing the electrostatic latent image formed on the organic photosensitive medium by using one or more developers;
an intermediate transfer belt to which a developed image is primarily transferred;
a secondary transfer unit for secondarily transferring the image to a paper; and
a control unit for controlling operations of the color printer.

13. The tone compensation method according to claim 12, wherein the print variables are comprised of at least one of a magnitude of a DC component of a developing voltage, a magnitude of an AC component of the developing voltage, a duty cycle of the AC component of the developing voltage, a charging voltage for the organic photosensitive medium, and a control voltage of the laser diode.

14. The tone compensation method according to claim 13, further comprising the step of:
changing the printing environment depending on changes of at least one of a temperature and humidity of the color printer, a characteristic of a power voltage supplied to the color printer, and a time-varying characteristic of components of the color printer.

15. The tone compensation method according to claim 13, wherein the object medium is comprised of at least one of the organic photosensitive medium and the intermediate transfer belt.

16. A color printer, comprising:
a memory unit for storing a reference tone reproduction curve of print colors based on a printing environment;
a sample pattern formation unit for forming sample patterns for one or more colors on a predetermined object medium;
a sectional tone reproduction curve formation unit for forming a sectional tone reproduction curve by using the sample patterns; and
a tone compensation unit for adjusting one or more print variables to compensate the sectional tone reproduction curve in order to reduce sectional errors between the reference tone reproduction curve and the sectional tone reproduction curve.

17. The color printer according to claim 16, wherein:
the memory unit is configured to store a tone compensation curve based on the print environment; and
wherein the reference tone reproduction curve has a complementary relation to the tone compensation curve.

18. The color printer according to claim 16, wherein the sample pattern formation unit is configured to form the sample patterns of one or more tones for one of one or more primary colors.

19. The color printer according to claim 16, wherein the sectional tone reproduction curve is configured to read the sample patterns and form the sectional tone reproduction curve based on a relation between the tone formed in the sample patterns and the tone read from the sample patterns.

20. The color printer according to claim 16, wherein the tone compensation unit comprises:
a compensation determination unit for determining whether or not compensation for the sectional tone reproduction curve is needed by using a sum of deviations determined based on quantities of the sectional errors; and
a sectional compensation unit for compensating the sectional tone reproduction curve by using weighted deviations determined by allocating weighted values to the sectional errors if the compensation is needed, wherein the memory unit is configured to store the adjusted print variables.

21. The color printer according to claim 20, wherein the compensation determination unit is configured to calculate the sum of deviations by summing absolute values of the sectional errors and determine that the compensation for the sectional tone reproduction curve is needed if the sectional errors are equal to or greater than a first threshold value.

22. The color printer according to claim 20, wherein the compensation determination unit is configured to calculate the sum of deviations by squaring the sectional errors and determine that the compensation for the sectional tone reproduction curve is needed if the sectional errors are equal to or greater than a first threshold value.

23. The color printer according to claim 20, wherein the sectional compensation unit is configured to:
divide the sectional tone reproduction curve into one or more sections based on tone and determine a degree of importance of at least one section;
determine weighted values according to the degrees of importance of the divided sections;
calculate the weighted deviations of the divided sections by allocating the weighted values to the sectional errors; and
adjust the print variables to compensate the sectional tone reproduction curve by using the weighted deviations.

24. The color printer according to claim 23, wherein the sectional compensation unit is configured to divide the sectional tone reproduction curve into at least three sections, and allocate a higher weighted value to a section having a lower tone in the sectional tone reproduction curve.

25. The color printer according to claim 20, wherein the tone compensation unit is configured to determine whether or not the weighted deviation is equal to or greater than a second threshold value and repeat compensation if the weighed deviation is equal to or greater than the second threshold value.

26. The color printer according to claim 16, wherein the color printer is an electronic-picture color printer comprising:
a charger for charging an organic photosensitive medium;
a laser diode for forming an electrostatic latent image on the organic photosensitive medium;
a developing unit for developing the electrostatic latent image formed on the organic photosensitive medium by using one or more developers;
an intermediate transfer belt to which a developed image is primarily transferred;
a secondary transfer unit for secondarily transferring the image to a paper; and
a control unit for controlling operations of the color printer.

27. The color printer according to claim 26, wherein the print variables are comprised of at least one of a magnitude of a DC component of a developing voltage, a magnitude of an AC component of the developing voltage, a duty cycle of the AC component of the developing voltage, a charging voltage for the organic photosensitive medium, and a control voltage of the laser diode.

28. The color printer according to claim 27, wherein the printing environment is changed depending on a change of at least one of a temperature and humidity of the color printer, a characteristic of a power voltage supplied to the color printer, and a time-varying characteristic of components of the color printer.

29. The color printer according to claim 27, wherein the sample pattern formation unit is comprised of a color tone density sensor for reading the patterns formed on at least one of the organic photosensitive medium and the intermediate transfer belt.
